(19) United States
(12) Patent Application Publication
(10) Pub. No.: US 2020/0393331 A1
(43) Pub. Date: Dec. 17, 2020

(54) TISSUE-EMBEDDED SECTION MANUFACTURING METHOD AND TISSUE-EMBEDDED SECTION MANUFACTURING APPARATUS

(71) Applicant: HITACHI, LTD., Tokyo (JP)

(72) Inventors: Chihiro MANRI, Tokyo (JP); Takeshi SAKAMOTO, Tokyo (JP); Osamu KOGI, Tokyo (JP); Hideyuki NODA, Tokyo (JP); Hiroki SAITO, Tokyo (JP)

(73) Assignee: HITACHI, LTD.

(21) Appl. No.: 15/930,108

(22) Filed: May 12, 2020

(30) Foreign Application Priority Data
Jun. 13, 2019 (JP) 2019-110163

(51) Int. Cl. G01N 1/06; G01N 1/28

(52) U.S. Cl. CPC G01N 1/06; G01N 2001/061; G01N 1/286

(57) ABSTRACT

The present disclosure proposes a tissue-embedded section manufacturing method in which a control unit controls an embedded section manufacturing operation of an embedded block having a tissue embedded therein by a microtome and a collection operation of an embedded section by a chip. The method includes driving the blade of the microtome by the control unit to slice the embedded block and manufacture an embedded section, and driving the chip by the control unit to suck and collect the embedded section attached to the blade.

### CROSS-REFERENCE TO RELATED APPLICATIONS

This application claims priority to Japanese Patent Application No. 2019-110163, filed Jun. 13, 2019, the contents of which are incorporated herein by reference.

### BACKGROUND OF THE INVENTION

### 1. Field of the Invention

The present disclosure relates to a tissue-embedded section (a “section” may be referred as a “slice” hereinafter) manufacturing method and a tissue-embedded section manufacturing apparatus.

### 2. Description of the Related Art

With the advent of the next-generation sequencer (NGS) launched in 2005, it has become possible to analyze the human genome in a short time and at low cost, and expectations for personalized medical care based on individual genome information have increased. Personalized medical care has been applied clinically in various fields such as hereditary diseases, prenatal diagnosis, and cancer genome medical care, and is mainly carried out with genetic testing.

Specimens used for genetic testing include FFPE (Formalin-Fixed Paraffin-Embedded) of tissues sampled and excised by biopsy, surgery, or the like, and nucleic acids (DNA, RNA) extracted from frozen tissues obtained by freezing tissues in buffer.

At present, FFPE and a frozen tissue are sliced into 3 to 10 μm by a device called a microtome, then attached to a glass slide, stained by a predetermined staining method, and then observed with a microscope for pathological diagnosis. Several literatures describe methods of automatically creating a slide from a slice (see JP 2009-168808 A, JP 2015-510579 A, and JP 2016-191708 A, for example).

### SUMMARY OF THE INVENTION

The main purpose of use of conventional FFPE and frozen tissues disclosed in JP 2009-168808 A, JP 2015-510579 A, and JP 2016-191708 A is microscopic observation with tissue staining. Therefore, a process of attaching an embedded section obtained by slicing with a microtome to a glass slide is essential.

However, it is important in genetic testing to extract nucleic acids from embedded sections. Therefore, it is essential to collect an embedded section with a tube or the like, without the need for attaching an embedded section to a slide.

Conventionally, a section obtained by slicing with a microtome is manually collected by the operator using tweezers or a brush. However, since an embedded section sticks to the blade, the collection tweezers, the brush, or the like, there is a problem that the section obtained by slicing is damaged during collection and the entire amount cannot be collected.

In view of such circumstances, the present disclosure proposes a technique that makes it possible to collect the entire amount of a tissue-embedded section obtained by slicing with a microtome.

In order to solve the above-described problem, the present disclosure proposes a tissue-embedded section manufacturing method in which a controller controls an embedded section manufacturing operation of an embedded block having a tissue embedded therein by a microtome and a collection operation of the embedded section by a chip, the method including: driving a blade of a microtome by a controller to slice an embedded block and manufacture an embedded section; and driving a chip by the controller to suck and collect the embedded section attached to the blade.

Further features related to the present disclosure will become apparent from the description of the present specification and the accompanying drawings. The aspects of the present disclosure are achieved and realized by elements, combinations of various elements, the following detailed description, and the appended claims.

It should be understood that the description herein is merely exemplary and is not intended to limit the scope of the claims or the application of the present disclosure in any way.

According to the technique of the present disclosure, it becomes possible to collect the entire amount of a tissue-embedded section obtained by slicing with a microtome.

### BRIEF DESCRIPTION OF THE DRAWINGS

FIG. 1 is a diagram illustrating a schematic configuration example of a tissue-embedded section manufacturing apparatus according to the present embodiment;

FIG. 2 is a flow chart for explaining operations in the tissue-embedded section manufacturing apparatus until a tissue-embedded section is manufactured from the embedded block and the entire amount is collected;

FIG. 3 is a schematic view of an operation of collecting an embedded section; and

FIGS. 4A and 4B are diagrams illustrating schematic configuration examples of a chip used for embedded section collection.

### DESCRIPTION OF THE PREFERRED EMBODIMENTS

The present embodiment relates to a method and an apparatus for manufacturing a tissue section with a microtome and collecting the manufactured tissue section. For example, in an embedded section manufacturing apparatus according to the present embodiment, a blade of a microtome is driven to slice an embedded block and manufacture an embedded section, and the chip is driven to suck and collect an embedded section attached to the blade. As a result, it becomes possible to collect the entire amount of a tissue-embedded section obtained by slicing with the microtome.

In the prior art, a blade of a microtome used for slicing, and tweezers and a brush for collection are not replaced in the process of manufacturing an embedded section for tissue staining. Therefore, when nucleic acid is extracted from an embedded section manufactured by the same method, there is a problem that other specimens are contaminated. In view of this, the present embodiment also proposes a technique for collecting the entire amount of a tissue-embedded section obtained by slicing without contamination with other specimens.

Hereinafter, an embodiment of the present disclosure will be described with reference to the accompanying drawings. In the accompanying drawings, functionally identical elements may be denoted by the same numbers. Although the accompanying drawings illustrate a specific embodiment and implementation examples based on the principle of the present disclosure, these are for the purpose of promoting understanding of the present disclosure and are not used to limit interpretation of the present disclosure in any way.

Although the present embodiment is described in sufficient detail for those skilled in the art to implement the present disclosure, it should be understood that other implementations and forms are possible, and the configuration or the structure can be changed and various elements can be replaced without departing from the scope and spirit of the technical idea of the present disclosure. Accordingly, the following description should not be interpreted as being limited to this.

Furthermore, as will be described later, embodiments of the present disclosure may be implemented by software running on a general-purpose computer, or may be implemented by dedicated hardware or a combination of software and hardware.

### Configuration Example of Tissue-Embedded Section Manufacturing Apparatus

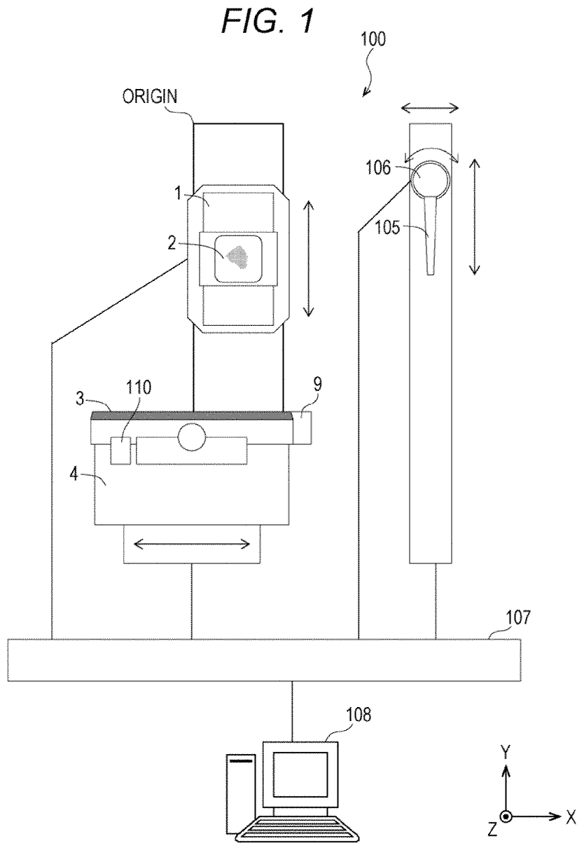

FIG. 1 is a diagram illustrating a schematic configuration example of a tissue-embedded section manufacturing apparatus 100 according to the present embodiment. The tissue-embedded section manufacturing apparatus 100 includes: an embedded block stage 101 that holds an embedded block 102; a blade 103 that slices the embedded block 102; a blade holder 104 that holds the blade 103; a chip 105 for collecting a section obtained by slicing; a chip hand 106 that holds the chip 105; a control unit (a “control unit” may be referred as a “controller” hereinafter) 107 that controls a cutting operation by the microtome and a section collection operation by the chip; a computer (PC) 108 that issues a command to the control unit 107; an image sensor 109 that captures an image of the blade 103; and a static electricity generation mechanism 110 that generates static electricity on the blade 103.

The tissue-embedded section manufacturing apparatus 100 also includes a drive mechanism, which is not shown in FIG. 1, for driving (moving) each of the embedded block stage 101, the blade holder 104, and the chip hand 106 in at least one of the X-axis direction, the Y-axis direction, and the Z-axis direction. Furthermore, in a case where a reference block is used as means for leveling the surface of the embedded block 102 (which will be described later), the embedded section manufacturing apparatus 100 may further include a reference block for leveling the surface (top) of the embedded block 102, and a drive mechanism for holding the reference block and pressing the reference block against the embedded block 102 placed on the embedded block stage 101.

Although the control unit 107 and the computer 108 are expressed as separate components in FIG. 1, one computer 108 may be configured to execute the function of the control unit 107. In either case, the computer 108 includes an input device (e.g., a keyboard, a mouse, a mechanical switch, a touch panel, a microphone, etc.) for inputting data, instructions, and information, and an output device (e.g., a display, a speaker, a printer, etc.) for outputting processing results.

The tissue-embedded section manufacturing apparatus 100 having the above-described configuration performs operations of thinly cutting the surface of the embedded block 102 placed and held on the embedded block stage 101 with the blade 103, and sucking and collecting the section obtained by slicing with the chip 105. This makes it possible to collect the entire amount of the tissue-embedded section obtained by slicing.

<Details of Operations from Tissue-Embedded Section Manufacturing to Collection>

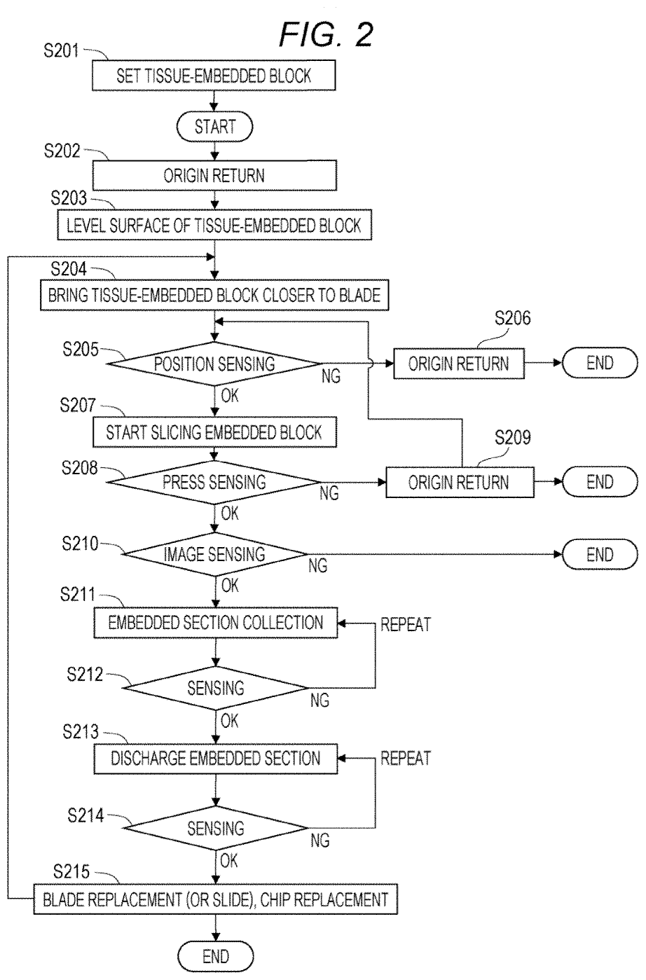

FIG. 2 is a flowchart for explaining operations in the tissue-embedded section manufacturing apparatus 100 until a tissue-embedded section is manufactured from the embedded block 102 and the entire amount is collected. Although the operation of the tissue-embedded section manufacturing apparatus 100 in each of the following steps is described with the operating configuration as the control unit 107, the operating configuration may be the computer 108 or another control apparatus (processor).

### (i) Step 201

When the user sets the embedded block 102 as a sample on the embedded block stage 101 and instructs operation start of the tissue-embedding section manufacturing apparatus 100 using the computer 108, the control unit 107 starts processing from step 202 in response to the instruction.

### (ii) Step 202

The control unit 107 executes initialization of the tissue-embedded section manufacturing apparatus 100. The initialization processing includes, for example, an origin return process of the embedded block stage 101. The origin of the embedded block stage 101 can be set, for example, at a location shown in FIG. 1.

(iii) Step 203

The control unit 107 levels the surface of the embedded block 102 set on the embedded block stage 101. Here, to level means to make the surface of the embedded block 102 parallel to the blade 103. As a leveling method, for example, a ranging sensor method or a reference block method may be used. The ranging sensor method is a method of, for example, measuring the height (distance) of two points in the horizontal direction and two points in the vertical direction of the embedded block 102 with a laser ranging sensor, calculating the tilt in two axial directions, and then moving the embedded block stage 101 according to the amount of deviation so as to level the surface of the embedded block 102. The reference block method is a method of, for example, minimizing the excitation torque of the embedded block stage 101 (minimizing the current sharing of the stage), making the holding force free, and then pressing the reference block that is in parallel with the blade 103 against the embedded block 102 so as to level the surface of the embedded block 102 with the reference block. Thereafter, the position of the embedded block 102 may be fixed by maximizing the excitation torque of the embedded block stage 101. The reference block may be, for example, replaced for each specimen or wiped with paper containing ethanol in order to prevent contamination with other specimens. The embedded block stage 101 may also be provided with a movable mechanism such as a gonio stage or an air gyro.

### (iv) Step 204

The control unit 107 moves the embedded block stage 101 in the Y-axis direction to bring the embedded block 102 closer to the blade 103.

### (v) Step 205

The control unit 107 determines the positional relationship between the embedded block 102 and the blade 103 by sensing. The positional relationship between the surface of the embedded block 102 and the tip of the blade 103 can be set so that no gap is formed. If there is a gap (in the case of NG in step 205), origin return of the embedded block stage may be performed (step 206), and the operation may be terminated. If there is no gap (in the case of OK in step 205), the process proceeds to step 207. The sensing can be, for example, sensing by an image sensor (therefore, the image sensor 109 is shown in FIG. 1). In this case, the image sensor 109 recognizes the distance between the blade 103 and the tip of the embedded block 102 using an image. Instead of sensing by an image sensor, for example, sensing may be performed by an optical sensor. In this case, the blade 103 and the embedded block 102 are located at predetermined positions and transmitted light from two LED lights is blocked, for example, so that whether there is a gap or not can be recognized. Furthermore, for example, a switch type sensor can be used. In this case, the control unit 107 moves the blade 103 and the embedded block 102 to predetermined positions, and recognizes the state in which the switch is pressed.

### (vi) Step 207

The control unit 107 moves the embedded block stage 101 along the Z axis by a predetermined thickness in accordance with desired section thickness information (e.g., 3.0 to 50 μm) inputted by the user using the computer 108, and then moves the blade 103 in the Y-axis direction so as to slice the embedded block 102 and manufacture an embedded section.

(vii) Step 208

The control unit 107 determines whether the embedded block 102 has been sliced by the blade 103 or not (whether a sliced section has actually been obtained or not) by press sensing. For sensing, a strain sensor can be used, for example. The control unit 107 controls pressure measurement using the strain sensor, and detects troubles/misses such as idling based on comparison between the obtained pressure and a preset threshold value (determines that idling has occurred if the pressure value is smaller than the threshold value, for example). If a trouble/a miss is detected (in the case of NG in step 208), the control unit 107 performs origin return of the embedded block stage 101 (step 209). If the number of times of origin return is equal to or larger than a predetermined number, the control unit 107 may terminate the embedded section manufacturing operation. If normal (in the case of OK in step 208), the process proceeds to step 210.

A table in which a section thickness value corresponding to the pressure value of the blade 103 against the embedded block 102 is held (a table in which section thickness values corresponding to the respective pressure values are stored) can be preset to be prepared in the internal memory of the control unit 107 or in an external storage that is not shown, for example. In this case, the control unit 107 can acquire a pressure value corresponding to a desired section thickness value inputted by the user and adjust the distance between the blade 103 and the embedded block 102 so as to get the pressure value.

(viii) Step 210

The control unit 107 determines whether there is an embedded section on the blade 103 or not by sensing (e.g., image sensing using an image sensor). Since an embedded section generally sticks to the blade with static electricity, no special action is required. However, in the present embodiment, a static electricity generation mechanism 110 that causes static electricity on the blade 103 is provided in order to surely cause an embedded section to stay on the blade 103.

If existence of an embedded section on the blade 103 is confirmed (in the case of OK in step 210), the process proceeds to step 211. If existence of an embedded section on the blade 103 is not confirmed (in the case of NG in step 210), the control unit 107 terminates the embedded section manufacturing operation.

### (ix) Step 211

The control unit 107 controls driving of the chip hand 106 and the suction operation of the chip 105 so as to collect (suck and collect) an embedded section attached to the blade 103.

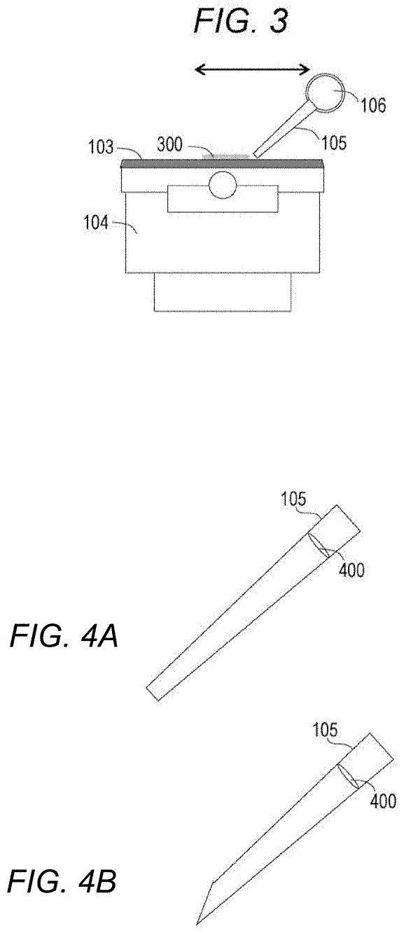

Here, the operation of collecting an embedded section will be described briefly. FIG. 3 is a schematic view of the operation of collecting an embedded section. The chip hand 106 is configured to change the angle of the chip 105 when being driven to rotate. However, the angle of the chip 105 may be constant, or may be instructed by the user by inputting an arbitrary angle value through the computer 108. The control unit 107 controls the drive mechanism (not shown) of the chip hand 106 to move the chip 105 in the X-axis direction along the tip of the blade 103 while sucking the chip 105 so as to collect the manufactured embedded section 300 into the chip 105. The suction operation can be performed by, for example, an aspirator pump connected to the chip hand 106.

Here, a configuration example of the chip 105 will also be described. FIGS. 4A and 4B are diagrams illustrating schematic configuration examples of the chip 105 used for embedded section collection. The chip 105 has a filter 400. The tip shape of the chip 105 may be either flat (see FIG. 4A: cut horizontally) or obliquely cut (see FIG. 4B). The diameter of the tip of the chip 105 can be 3 mm to 10 mm, for example. The filter 400 is required to prevent the collected embedded section 300 from being sucked into the pump. The pore size of the filter 400 can be 0.22 to 1 μm. Furthermore, the specifications of the chip 105 including the filter 400 may be DNase-free and RNase-free, and low nucleic acid adsorption may be employed.

### (x) Step 212

The control unit 107 determines whether there is an embedded section 300 on the blade 103 or not by sensing (e.g., sensing by the image sensor 109). If it is determined that an embedded section 300 remains on the blade 103 (in the case of NG in step 212), the process returns to step 211, and the collection process is repeated. If it is determined that no embedded section 300 remains on the blade 103 (in the case of OK in step 212), the process proceeds to step 213.

### (xi) Step 213

The control unit 107 discharges the embedded section 300 sucked and collected into the chip 105 into a tube (not shown). The discharge operation can be realized by, for example, connecting a compressor to the chip hand 106 and discharging the embedded section 300 with air. The aspirator pump and the compressor for collecting the embedded section 300 may be installed separately, or one pump may be provided and suction (intake) and discharge (exhaust) may be switched with a valve. The specifications of the tube for collecting the embedded section 300 may be DNase-free and RNase-free, and low nucleic acid adsorption may be employed as with the chip 105.

(xii) Step 214

The control unit 107 determines whether there is an embedded section in the chip 105 or not (whether an embedded section remains or not) by sensing (e.g., a small image sensor provided in the chip 105 or an image sensor installed in a tube). If it is determined that an embedded section remains in the chip 105 (in the case of NG in step 214), the process returns to step 213, and the discharge process is repeated. If it is determined that no embedded section remains in the chip 105 (in the case of OK in step 214), the process proceeds to step 215.

(xiii) Step 215

The control unit 107 controls each drive mechanism to replace the blade 103 or slide the blade 103, and replace the chip 105 for embedded section collection. The operation may be preset to operate automatically, or a command for replacement, for example, may be inputted by the user. In either case, the control unit 107 executes the operation in response to an automatic replacement command or a command from the user.

If the embedded block 102 shifts to section manufacturing of a different specimen, it is desirable to replace the blade 103 in order to prevent contamination. If the embedded block 102 continuously manufactures a section of the same specimen, steps 202 to 214 are performed once, and then the blade holder 104 is moved in the X-axis direction so that the blade 103 is slid. The slide pitch can be set to the length of the embedded block 102 in the X direction. This makes it possible to avoid the inconvenience that a desired amount of embedded sections cannot be acquired due to the deterioration of the blade 103.

Regarding the chip 105, it is also desirable to replace the chip 105 in order to prevent contamination when the embedded block 102 shifts to a section manufacturing operation of a different specimen. If the embedded block 102 continuously manufactures an embedded section of the same specimen, the chip 105 can be continuously used without being replaced.

### SUMMARY

In a tissue-embedded section manufacturing apparatus according to the present embodiment, it becomes possible to automatically manufacture and collect an embedded section that has been performed manually, and this can contribute to reduction of burden on the operator. Moreover, by providing a mechanism for checking slicing of an embedded section, a mechanism for checking collection to the chip, and a mechanism for checking discharge to the tube, it is possible to contribute to collection of the entire amount of valuable pathological tissue. Furthermore, since the blade for manufacturing an embedded section and the chip for collecting the embedded section are replaced for each specimen, contamination with other specimens can be prevented, and the genetic test data can be improved in reliability.

For example, according to a tissue-embedded section manufacturing apparatus of the present embodiment, the control unit (a processor such as a CPU) drives a blade of a microtome to slice an embedded block and manufacture an embedded section, and drives a chip to suck and collect the embedded section attached to the blade. As a result, it becomes possible to collect the entire amount of the valuable pathological tissue.

In the tissue-embedded section manufacturing apparatus, the control unit executes an operation of leveling the surface of the embedded block. The control unit then checks the positional relationship between the embedded block and the blade, and determines whether the embedded block can be sliced or not. This makes it possible to manufacture an embedded section having a uniform thickness corresponding to the thickness specified by the user.

Furthermore, the control unit determines whether all of the embedded section attached to the blade has been collected by the chip or not, and continues sucking by the chip until it is confirmed that the entire amount has been collected. The control unit also drives the chip to discharge the collected embedded section to the tube, and checks whether the collected embedded section remains in the chip or not. This makes it possible to ensure collection of the entire amount of the pathological tissue.

In the tissue-embedded section manufacturing apparatus, the control unit replaces the chip with a new chip, replaces the blade, or slides the cut position of the embedded block of the blade after the chip causes the embedded section to protrude to the tube. This makes it possible to manufacture and collect an embedded section without causing contamination with other specimens.

The functions of the present embodiment can also be realized by software program codes. In this case, a storage medium on which a program code is recorded is provided in a system or an apparatus, and a computer (or a CPU or an MPU) of the system or the apparatus reads the program code stored in the storage medium. In this case, the program code itself read from the storage medium realizes the function of the above-described embodiment, and the program code itself and the storage medium on which the program code is recorded constitute the present disclosure. Used as a storage medium for supplying such a program code are, for example, a flexible disk, a CD-ROM, a DVD-ROM, a hard disk, an optical disk, a magneto-optical disk, a CD-R, a magnetic tape, a nonvolatile memory card, a ROM, and the like.

Moreover, an OS (operating system) running on a computer may perform part or all of the actual processing based on instructions of the program code, so that the function of the above-described embodiment is realized by the processing. Furthermore, after the program code read from the storage medium is written in the memory on the computer, the CPU of the computer or the like may perform part or all of the actual processing based on the instruction of the program code, so that the function of the above-described embodiment is realized by the processing.

Furthermore, a software program code that realizes the function of the embodiment is distributed via a network, so that the program code is stored in storage means such as a hard disk or a memory of a system or an apparatus or in a storage medium such as a CD-RW or a CD-R, and a computer (or a CPU or an MPU) of the system or the apparatus may read and execute the program code stored in the storage means or the storage medium when used.

Finally, it should be understood that the processes and techniques described herein are not inherently related to any particular apparatus, and can be implemented by any suitable combination of components. Furthermore, various types of devices for general purpose can be used in accordance with the teachings described herein. It may prove useful to build a dedicated device to execute the steps of the method described herein. Moreover, various inventions can be formed by appropriately combining a plurality of components disclosed in the embodiment. For example, some components may be deleted from all the components illustrated in the embodiment. Furthermore, components over different embodiments may be appropriately combined. Although the present disclosure has been described with reference to specific examples, these are in all respects illustrative rather than restrictive. Those skilled in the art will recognize that there are numerous combinations of hardware, software, and firmware that are suitable to implement the present disclosure. For example, the described software can be implemented in a wide range of programs or script languages such as assembler, C/C++, perl, Shell, PHP, and Java (registered trademark).

Furthermore, in the above-described embodiment, control lines and information lines that are considered necessary for explanation are illustrated, and not all control lines and information lines on the product are necessarily shown. All the components may be connected to each other.

In addition, other implementations of the present disclosure will become apparent to those having ordinary skill in the art from consideration of the specification and embodiment of the present disclosure disclosed herein. The specific examples described herein are merely exemplary, and the scope and spirit of the present disclosure is set forth in the claims that follow.

What is claimed is:

1. A tissue-embedded section manufacturing method in which a controller controls an embedded section manufacturing operation of an embedded block having a tissue embedded in the embedded block by a microtome and a collection operation of an embedded section by a chip, the tissue-embedded section manufacturing method including:
driving a blade of the microtome by the controller to slice the embedded block and manufacture an embedded section; and
driving the chip by the controller to suck and collect the embedded section attached to the blade.

2. The tissue-embedded section manufacturing method according to claim 1, further including
executing a leveling operation of a surface of the embedded block by the controller.

3. The tissue-embedded section manufacturing method according to claim 1, further including
checking a positional relationship between the embedded block and the blade and determining whether the embedded block can be sliced or not by the controller.

4. The tissue-embedded section manufacturing method according to claim 1, further including
determining whether all of the embedded section attached to the blade has been collected by the chip or not by the controller.

5. The tissue-embedded section manufacturing method according to claim 1, further including
driving the chip by the controller to discharge the collected embedded section to a tube.

6. The tissue-embedded section manufacturing method according to claim 5, further including
checking whether a collected embedded section remains in the chip or not by the controller.

7. The tissue-embedded section manufacturing method according to claim 5, further including
replacing the chip with a new chip by the controller after the chip causes the embedded section to protrude to the tube.

8. The tissue-embedded section manufacturing method according to claim 5, further including
replacing the blade or sliding a cutting position of the embedded block of the blade by the controller.

9. The tissue-embedded section manufacturing method according to claim 1,
wherein the controller drives a chip including a filter to suck and collect the embedded section.

10. The tissue-embedded section manufacturing method according to claim 1,
wherein the controller moves the chip along the blade to suck and collect the tissue-embedded section.

11. A tissue-embedded section manufacturing apparatus for manufacturing and collecting an embedded section of an embedded block having a tissue embedded in the embedded block, the tissue-embedded section manufacturing apparatus comprising:
an embedded block stage on which the embedded block is placed;
a blade that slices the embedded block;
a chip that sucks and collects an embedded section obtained by slicing; and
a controller that controls a cutting operation of the embedded block by the blade and a sucking and a collection operation by the chip.

12. The tissue-embedded section manufacturing apparatus according to claim 11, further comprising
an image sensor that is installed in a blade holder that holds the blade, and captures an image of the blade,
wherein the controller checks a positional relationship between the embedded block and the blade based on an image captured by the image sensor, and checks whether an embedded section is attached to the blade or not.

13. The tissue-embedded section manufacturing apparatus according to claim 12,
wherein the controller controls driving of the chip to discharge the embedded section collected by the chip to a tube, and checks whether an embedded section remains in the chip or not after the discharge operation.

14. The tissue-embedded section manufacturing apparatus according to claim 11,
wherein the controller controls a replacement operation of a used chip in response to a chip replacement command.

15. The tissue-embedded section manufacturing apparatus according to claim 11,
wherein the controller controls operation of the blade holder that holds the blade so that the blade is replaced or a cutting position of the blade relative to the embedded block is slid in response to a blade replacement command or a blade slide command.
